(19) United States
(12) Patent Application Publication
(10) Pub. No.: US 2023/0309557 A1
(43) Pub. Date: Oct. 5, 2023

(54) A SOLID AGROCHEMICAL COMPOSITION AND PROCESS OF PREPARATION THEREOF

(71) Applicant: UPL Limited, Mumbai (IN)

(72) Inventors: Vikas Vinayak Oltikar, Mumbai (IN); Pradeep Shamrao Sapkale, Mumbai (IN); Anil Saini, Mumbai (IN); Rajan Ramakant Shirsat, Mumbai (IN)

(21) Appl. No.: 18/005,000

(22) PCT Filed: Jul. 10, 2021
(86) PCT No.: PCT/IB2021/056214

§ 371 Date: Jan. 10, 2023

(30) Foreign Application Priority Data
Jul. 11, 2020 (IN) 202021029513

(51) Int. Cl. A01N 37/22; A01N 25/14; A01N 25/32; A01N 43/54; A01N 31/14; A01P 13/00

(52) U.S. Cl. CPC A01N 37/22; A01N 25/14; A01P 13/00; A01N 43/54; A01N 31/14; A01N 25/32

(57) ABSTRACT

The present disclosure relates to a stable solid agrochemical composition includes: a chloroacetanilide herbicide; a second herbicide; and a suspensibility promoting agent. In said composition, the second herbicide is one or more of a sulfonylurea herbicide, an anilide herbicide, a triazinone herbicide, a salt or derivative thereof. A process of preparing the stable solid agrochemical composition, and a method of controlling weeds using said composition as herbicide are also disclosed.

### FIELD OF THE DISCLOSURE

The present disclosure relates to a solid agrochemical composition. More particularly, the present disclosure relates to a solid agrochemical composition comprising an otherwise liquid active ingredient and a process of preparation of said solid agrochemical composition.

### BACKGROUND

Rice and upland cereals such as wheat, barley, and oats satisfy the food need of a large portion of the world's population. Rice is a staple crop for millions of people around the world whose diet depends on its availability. Rice is a semi-aquatic crop that benefits from flooded soil conditions during part or all of the growing season. Generally, rice is grown on flooded soils to optimize grain yields. Heavy clay soils or silt loam soils with hard pan layers about 30 cm below the surface are typical rice-producing soils because they minimize water losses from soil percolation. The fields are typically flooded under 10-12 cm deep water at the time of sowing and during early stages of growth. Therefore, the fields should be level and have low mud walls to retain water.

Rice production is frequently restricted by the prevalence of weeds that flourish in commercial rice fields. Unchecked weed growth in rice crops can cause significant losses, reducing profit to the farmer and increasing costs to the consumer. The continued population increase, and concomitant food shortage increase the need for improvements in the production of rice crops. Improving the efficiency of rice crop production by controlling undesirable weeds through the application of herbicides is continually being sought.

Herbicides are known to control weed growth. As a common practice to avoid resistance and for the purpose of broad-spectrum coverage, more than one herbicide are often combined together. Herbicides, either solo or in combination, are formulated in various types of formulations considering the purpose of application and ease of operation to control pests and weeds. A solid granular form is frequently used as a preferred formulation type based on ease of preparation as well as application.

Solid granular formulations offer significant advantages such as ease of handling, ease of use, reduced work exposure, reduced spillage and waste disposal, and less field drift.

The chloroacetanilide herbicide, [2-chloro-2,6-diethyl-N-(2-propoxyethyl) acetanilide] (pretilachlor) is widely used in rice cultivation for the control of several grasses, broad-leaved weeds and sedges. Pretilachlor works by inhibiting cell division. It is a selective herbicide and can be taken up readily by the hypocotyls, mesocotyls and coleoptiles, and, to a lesser extent, by the roots of germinating weeds. Pretilachlor is used either as a pre-planting or post-emergence application. To increase the spectrum of activity and coverage, pretilachlor is often combined with other agrochemical ingredients.

For example, pretilachlor can be combined with herbicide safeners for agricultural weed control. Herbicide safeners, formerly referred to as herbicide antidotes, are chemical agents that increase the tolerance of monocotyledonous cereal plants to herbicides without affecting the weed control effectiveness. There are several herbicide safeners available for use with pretilachlor. The combination of pretilachlor combination with herbicide safeners offers effective control of weeds and at the same time, crops do not suffer herbicide injury.

Another chloroacetanilide herbicide, propisochlor, penetrates through the underground organs of weeds during germination or at the seedling stage. On the one hand, it inhibits the synthesis of proteins and nucleic acids, on the other hand it inhibits the growth of roots. The reduction in osmotic potential resulting from these actions causes rapid death of weeds. Chloroacetanilide herbicides, such as pretilachlor and propisochlor, are often combined with other herbicides for providing broad spectrum control to crops against weeds.

When liquid chloroacetanilide herbicides are to be combined with other agrochemical ingredients which exist in solid state, formulators must adopt novel formulation techniques. It has been noticed that when pretilachlor or propisochlor is combined with other herbicides, formulators struggle to achieve the desired suspensibility and dispersibility of active ingredients, thus careful selection of auxiliary agents such as emulsion stabilizers and surfactants become very important.

Several attempts have been made in the prior art to develop solid compositions of pretilachlor.

U.S. Pat. No. 6,673,747 B2 discloses a liquid herbicidal composition containing pretilachlor that is suspended or dissolved in a non-aqueous liquid phase, an herbicide of the sulfonylurea type that is suspended in a non-aqueous liquid phase, and at least one surface-active substance. The non-aqueous phase comprises a vegetable or mineral oil or a mixture thereof. The '747 patent discloses effective weed control and reduced phytotoxicity of the compositions, however, storage stability related parameters are not described.

Indian Patent No. 210952 discloses a synergistic herbicidal composition comprising a selective herbicide pyrazosulfuron ethyl in combination with at least another herbicide selected from butachlor, pretilachlor, and 2,4-D. The '952 patent teaches several emulsifiable concentrate (EC) formulations comprising pyrazosulfuron ethyl in an amount of 3%, 1%, 1.4%, 2% and 50% in combination with pretilachlor in an amount of about 35%, 40%, 40%, 50% and 50% respectively. Further, the '952 patent teaches that pyrazosulfuron ethyl and pretilachlor offer remarkably synergistic weed control within a ratio of 1:9 to about 1:59. Moreover, the '952 patent suggests preparation of the synergistic compositions of pyrazosulfuron ethyl in combination with pretilachlor in either concentrated liquid or as a granular formulation. However, a stable granular formulation comprising pyrazosulfuron ethyl and pretilachlor is not described.

JPH04297403 discloses herbicidal preparations as tablets or capsules containing a sulfonylurea herbicidal and other liquid herbicidal components, wherein a solid herbicide is impregnated with a liquid herbicide using a specific oil-absorbing base material to obtain a tablet or capsule suitable for weeding rice paddy fields. However, tablets or capsules are used for broadcasting applications and not very successful for foliar application.

WO2012042316A1 discloses a storage stable granular formulation comprising pretilachlor and pyrazosulfuron ethyl using sodium lignosulfonate which is substantially free of a reducing sugar as a stabilizing agent. The stabilizing agent controls degradation of pyrazosulfuron ethyl in the presence of pretilachlor. The suspensibility of pretilachlor was not addressed.

Despite all the advances, there is a continuing need to develop effective compositions of chloroacetanilide herbicides and also compositions of chloroacetanilide herbicides in combination with other herbicides.

### OBJECTIVES

An object of the present disclosure is to provide stable agrochemical composition of chloroacetanilide herbicide in combination with at least one more herbicide.

Another object of the present invention is to provide stable solid agrochemical composition of chloroacetanilide herbicide in combination with at least one more herbicide.

Another object of the present invention is to provide stable solid agrochemical composition of chloroacetanilide herbicide in combination with at least one more herbicide wherein high loading of chloroacetanilide herbicide is achieved.

Still another object of the present invention is to provide stable solid agrochemical composition of chloroacetanilide herbicide in combination with at least one more herbicide, and safeners, that can be applied onto crops, especially rice/paddy crops.

Further object of the present invention is to provide a process of preparing stable solid agrochemical composition comprising chloroacetanilide herbicide and at least one more herbicide.

### SUMMARY

In an aspect, a stable solid agrochemical composition comprises:
a. a chloroacetanilide herbicide;
b. a second herbicide, a salt or derivative thereof; and
c. a suspensibility promoting agent.

Another aspect provides a stable solid agrochemical composition comprising:
a. a chloroacetanilide herbicide;
b. one or more of a sulfonylurea, an anilide, a triazine, or a triazinone herbicide, a salt or derivatives thereof; and
c. a suspensibility promoting agent.

Another aspect provides a stable solid agrochemical composition comprising:
a. pretilachlor;
b. one or more of a sulfonylurea herbicide, an anilide herbicides, or a salt and derivatives thereof; and
c. a suspensibility promoting agent.

Another aspect provides a stable solid agrochemical composition comprising:
a. propisochlor;
b. one or more of a triazine or a triazinone herbicide, a salt and derivatives thereof; and
c. a suspensibility promoting agent.

An aspect provides a stable solid agrochemical composition comprising:
a. a chloroacetanilide herbicide;
b. one or more of a sulfonylurea, an anilide, a triazine or a triazinone herbicide, or a salt and derivatives thereof;
c. a safener; and
d. a suspensibility promoting agent.

Another aspect provides a stable solid agrochemical composition comprising:
a. pretilachlor;
b. at least one or more of a sulfonylurea and an anilide herbicid, or a salt and derivatives thereof; and
c. a safener; and
d. a suspensibility promoting agent.

Another aspect provides a process of preparing a stable solid agrochemical composition wherein said process comprises:
(a) preparing a liquid portion by adding a chloroacetanilide herbicide, a suspensibility promoting agent, and optionally other auxiliary agents;
(b) separately, preparing a solid portion by adding one or more of a sulfonylurea, an anilide, a triazine or a triazinone herbicide, or a salt or derivative thereof and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) one or more of the sulfonylurea, the anilide, the triazine or the triazinone herbicide, or the salt or derivative thereof; (c) the suspensibility promoting agent; and the optionally other auxiliary agents.

Another aspect provides a method of controlling unwanted weeds, said method comprising applying an effective amount of stable solid agrochemical composition comprising (a) a chloroacetanilide herbicide, (b) a second herbicide, its salt or derivative and (c) a suspensibility promoting agent to the weeds or to their locus.

Another aspect provides a method of controlling unwanted weeds, said method comprising applying an effective amount of stable solid agrochemical composition comprising (a) a chloroacetanilide herbicide, (b) a second herbicide, or a salt or derivative, (c) a safener and (d) a suspensibility promoting agent to the weeds or to their locus.

Another aspect provides a method of controlling germination loss in crop seeds, said method comprising applying an effective amount of stable solid agrochemical composition comprising (a) a chloroacetanilide herbicide, (b) a second herbicide, or a salt or derivative, (c) a safener and (d) a suspensibility promoting agent to the crop seeds or to their locus.

Another aspect provides the use of stable solid agrochemical composition as an herbicide.

An aspect of the present disclosure provides a kit comprising a stable solid agrochemical composition according to the present disclosure.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION

Surprisingly, the inventors found that the suspensibility of the chloroacetanilide herbicides in compositions comprising combinations with one or more second herbicides can be enhanced by incorporating a suspensibility promoting agent. The density of the chloroacetanilide herbicide, pretilachlor, for example is higher than water. Compositions comprising pretilachlor or propisochlor face low suspensibility issues when such compositions are diluted with water during application. This low suspensibility problem further aggravates when pretilachlor or propisochlor is formulated in combination with other herbicides. A suspensibility promoting agent aids in managing the suspensibility of liquid chloroacetanilide herbicides by holding them in the dispersion and preventing them from phasing out from the composition.

Physicochemical parameters such as suspensibility, wet sieve test, wetting time, and particle size are some of the important quality indicators of agrochemical compositions. And, among these, the most important quality indicator is suspensibility, which refers to the % of agrochemical ingredients to remain in suspension after a given time. High suspensibility signifies uniform distribution of an active ingredient in water and the uniform spray concentration.

### Definition(s)

The term “herbicide” is used herein to mean an active ingredient or a composition that kills, controls or otherwise adversely modifies the growth of weed plants.

As described herein, “effective amount” is an amount of active ingredient such as an herbicide which causes an adversely modifying effect and includes deviations from natural development, killing, regulation, desiccation, retardation, and the like.

As described herein, “suspensibility promoting agents” are non-ionic and anionic surfactants that aid in improving suspensibility of chloroacetanilide herbicide above 70%. The suspensibility is measured according to CIPAC guidelines such as MT 184, MT 15, MT 177, MT 161, MT 168, and MT 184.1.

As described herein, “controlling germination loss” is the percentage reduction in seed germination or reduction of phytotoxicity on crops receiving composition of the present disclosure.

The inventors observed that the solid agrochemical compositions as described herein are stable and can maintain good suspensibility of chloroacetanilide herbicides i.e. above 70% when diluted with water for the purpose of application to crops such as rice/paddy crops, soybean, rapeseed. As used herein, “stable” means that greater than about 70 wt %, preferably greater than about 75 wt %, or more preferably greater than 80 wt % of the chloroacetanilide herbicides in the solid agrochemical compositions remain suspended when measured according to CIPAC guidelines.

Therefore, present disclosure provides a stable solid agrochemical composition comprising:
a. a chloroacetanilide herbicide;
b. a second herbicide, or a salt thereof or derivative; and
c. a suspensibility promoting agent.

According to an embodiment of the present disclosure, a stable solid agrochemical composition comprises a chloroacetanilide herbicide.

According to an embodiment of the present disclosure, the chloroacetanilide herbicide of the stable solid agrochemical composition is pretilachlor.

According to an embodiment of the present disclosure, the chloroacetanilide herbicide of the stable solid agrochemical composition is propisochlor.

In an embodiment, the present disclosure provides a stable solid agrochemical composition comprising from about 1% w/w to about 50% w/w, preferably from about 5% w/w to about 45% w/w chloroacetanilide herbicide based on the total weight of the stable solid agrochemical composition.

In a preferred embodiment of the present disclosure, the stable solid agrochemical composition comprises from about 10% w/w to about 40% w/w chloroacetanilide herbicide based on the total weight of the stable solid agrochemical composition.

According to an embodiment of the present disclosure, the stable solid agrochemical composition comprises a suspensibility promoting agent.

In an embodiment, the suspensibility promoting agent includes one or more of dodecylbenzene sulfonate, sulfosuccinate, ethoxylated tristyrylphenol sulfate or phosphate, alcohol ether sulfonate, ethoxylated phenol sulfonate or polycarboxylate, polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, ethoxylated vegetable oil, ethoxylated fat alcohol, ethoxylated alkylphenol, ethoxylated polyethylene glycol and polypropylene glycol and copolymers thereof, ethoxylated tristyrylphenol derivative, oleyl polyglycol ether or silicone surfactant, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone or copolymers of (meth)acrylic acid and (meth)acrylic esters.

Preferably, the suspensibility promoting agent includes one or more of ethoxylated tristyrylphenol sulfate or phosphate, ethoxylated vegetable oil, ethoxylated fat alcohol, ethoxylated alkylphenol, ethoxylated polyethylene glycol and polypropylene glycol and copolymers thereof, ethoxylated tristyrylphenol derivative, polyethylene oxide/polypropylene oxide block copolymers, copolymers of polyvinyl alcohol and polyvinylpyrrolidone and copolymers of (meth)acrylic acid or (meth)acrylic esters.

More preferably, the suspensibility promoting agent includes one or more of ethoxylated tristyrylphenol sulfate or phosphate, ethoxylated vegetable oil, ethoxylated fat alcohol, or derivatives thereof.

In an embodiment, the present disclosure provides a stable solid agrochemical composition comprising from about 0.1% w/w to about 20% w/w, preferably from about 0.5% w/w to about 15% w/w suspensibility promoting agent based on the total weight of the stable solid agrochemical composition.

Preferably, the stable solid agrochemical composition comprises from about 1% w/w to about 10% w/w suspensibility promoting agent based on the total weight of the stable solid agrochemical composition.

According to an embodiment of the present disclosure, a stable solid agrochemical composition comprises:
a. a chloroacetanilide herbicide;
b. one or more of a sulfonylurea, an anilide, a triazine or a triazinone herbicide, or a salt or derivatives thereof; and
c. a suspensibility promoting agent.

According to an embodiment of the present disclosure, the stable solid agrochemical composition comprises at least one more herbicides selected from sulfonylurea, anilide, triazine or triazinone herbicides, or salts and derivatives thereof.

According to an embodiment of the present disclosure, the stable solid agrochemical composition comprises a sulfonylurea herbicide, or a salt or derivative thereof.

According to an embodiment of the present disclosure, the sulfonylurea herbicide comprises amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, salts or derivatives thereof, or a combination thereof.

According to an embodiment of the present disclosure, the sulfonylurea herbicide comprises bensulfuron, ethoxysulfuron, halosulfuron, nicosulfuron, propyrisulfuron, pyrazosulfuron, rimsulfuron, chlorsulfuron, metsulfuron, tribenuron, salts and derivatives thereof, or a combination thereof.

According to an embodiment of the present disclosure, the sulfonylurea herbicide is pyrazosulfuron, its salt or derivative, or a combination thereof.

According to an embodiment of the present disclosure, the sulfonylurea herbicide is pyrazosulfuron-ethyl.

According to an embodiment of the present disclosure, the sulfonylurea herbicide is bensulfuron, its salt or derivative, or a combination thereof.

According to an embodiment of the present disclosure, the sulfonylurea herbicide is nicosulfuron, its salt or derivative, or a combination thereof.

According to an embodiment of the present disclosure, the sulfonylurea herbicide is metsulfuron, its salt or derivative, or a combination thereof.

In an embodiment, the present disclosure provides a stable solid agrochemical composition comprising from about 0.1% w/w to about 15% w/w, preferably from about 0.5% w/w to about 10% w/w sulfonylurea herbicide based on the total weight of the stable solid agrochemical composition.

In a preferred embodiment of the present disclosure, the stable solid agrochemical composition comprises from about 1% w/w to about 5% w/w sulfonylurea herbicide based on the total weight of the stable solid agrochemical composition.

According to an embodiment of the present disclosure, the stable solid agrochemical composition comprises an anilide herbicide, its salt or derivative, or a combination thereof.

According to an embodiment of the present disclosure, the stable solid agrochemical composition comprises an anilide herbicide comprising chloranocryl, cisanilide, clomeprop, cypromid, diflufenican, etobenzanid, fenasulam, flufenacet, flufenican, ipfencarbazone, mefenacet, mefluidide, metamifop, monalide, naproanilide, pentanochlor, picolinafen, propanil, sulfentrazone, triafamone, salts or derivatives thereof, or a combination thereof.

According to an embodiment of the present disclosure, the stable solid agrochemical composition comprises an anilide herbicide comprising flufenacet, mefenacet, metamifop, monalide, naproanilide, picolinafen, propanil, sulfentrazone, salts or derivatives thereof, or a combination thereof.

According to an embodiment of the present disclosure, the anilide herbicide is propanil.

According to an embodiment of the present disclosure, the anilide herbicide is sulfentrazone.

According to an embodiment of the present disclosure, the anilide herbicide is flufenacet.

In an embodiment, the present disclosure provides a stable solid agrochemical composition comprising from about 0.1% w/w to about 50% w/w, preferably from about 0.5% w/w to about 40% w/w anilide herbicide of the total weight of the stable solid agrochemical composition.

In a preferred embodiment of the present disclosure, the stable solid agrochemical composition comprises from about 1% w/w to about 30% w/w anilide herbicide of the total weight of the stable solid agrochemical composition.

According to an embodiment of the present disclosure, triazine herbicides comprise atrazine, propazine, indaziflam, terbumeton, ametryn, terbutryn, or a combination thereof.

According to an embodiment of the present disclosure, triazinone herbicides comprises ametridione, amibuzin, metribuzin, metamitron, trifludimoxazin, or a combination thereof.

According to an embodiment of the present disclosure, triazinone herbicide is metribuzin.

In an embodiment, the present disclosure provides a stable solid agrochemical composition comprising from about 1% w/w to about 100% w/w of a triazine or triazinone herbicide of the total weight of the stable solid agrochemical composition.

In an embodiment, the present disclosure provides a stable solid agrochemical composition comprising from about 0.1% w/w to about 50% w/w, preferably from about 1% w/w to about 45% w/w triazine or triazinone herbicide based on the total weight of the stable solid agrochemical composition.

According to an embodiment, the stable solid agrochemical composition comprises:
a. pretilachlor;
b. one or more of sulfonylurea and anilide herbicides, or a salt or derivatives thereof; and
c. a suspensibility promoting agent.

According to an embodiment, the stable solid agrochemical composition comprises:
a. propisochlor;
b. one or more of triazine or triazinone herbicides, or a salt and derivatives thereof; and
c. a suspensibility promoting agent.

According to an embodiment of the present disclosure, a stable solid agrochemical composition comprises:
a. a chloroacetanilide herbicide;
b. one or more of sulfonylurea and anilide herbicides, or a salt and derivatives thereof; and
c. a safener; and
d. a suspensibility promoting agent.

According to an embodiment of the present disclosure, stable solid agrochemical composition comprises of a safener.

According to an embodiment of the present disclosure, safener is selected from the group benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, metcamifen, naphthalic anhydride, oxabetrinil, and combinations thereof.

According to an embodiment of the present disclosure, safener is selected from the group benoxacor, fenclorim, cloquintocet-mexyl, dichlormid, and combinations thereof.

According to preferred embodiment of the present disclosure, safener is fenclorim.

In an embodiment, the present disclosure provides a stable solid agrochemical composition comprising from about 1% w/w to about 40% w/w, preferably from about 5% w/w to about 40% w/w safener based on the total weight of the stable solid agrochemical composition.

In a preferred embodiment of the present disclosure, the stable solid agrochemical composition comprises from about 10% w/w to about 30% w/w safener based on the total weight of the stable solid agrochemical composition.

The stable solid agrochemical composition of the present disclosure may further comprise one or more of auxiliary agents selected from dispersants, wetting agents, fillers, surfactants, anticaking agents, pH-regulating agents, preservatives, biocides, antifoaming agents, colorants and other formulation aids.

Exemplary dispersants include ionic and nonionic dispersants such as salts of polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid, such as sodium lignosulphonate and modified sodium lignosulfonate; polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates ethoxylated alkylarylphosphated a sulphated ester.

Exemplary wetting agents includesoaps, silicone oil, magnesium stearate, salts of aliphatic monoesters of sulphuric acid including but not limited to sodium lauryl sulphate, sulfoakylamides and salts thereof including but not limited to N-methyl-N-oleoyltaurate sodium salt, alkylarylsulfonates including but not limited to akylbenzenesulfonates, akylnaphthalenesulfonates and salts thereof, and salts of ligninsulfonic acid including but not limited to sodium diisopropyl naphthalene sulfonate.

Exemplary fillers includeinsoluble fillers and soluble fillers like silica, amorphous silica, fumed diatomaceous earth kaolin, clay, bentonite.

Exemplary antifoams include silicones, long-chain alcohols and salts of fatty acids.

Exemplary colorants include, for example, red, blue and green colorants and are, preferably pigments, which are sparingly soluble in water, and dyes, which are water-soluble. Examples are inorganic coloring agents such as iron oxide, titanium oxide, and iron hexacyanoferrate and organic coloring agents such as alizarin, azo and phthalocyanin coloring agents.

According to an embodiment of the present disclosure, the stable solid agrochemical is preferably formulated as a solid composition including, but not limited to, dust, powder, granules, pellets, tablets, dry flowable, wettable powder, water effervescent granules, water dispersible granules (WDG) and water emulsifiable granules.

In a preferred embodiment, the stable solid agrochemical composition of the present disclosure is a water dispersible granule (WDG) formulation.

According to an embodiment of the present disclosure, the stable solid agrochemical composition comprises from about 1% w/w to about 50% w/w of a chloroacetanilide herbicide, from about 0.1% w/w to about 15% w/w of a second herbicide and from about 0.1% w/w to about 20% w/w of a suspensibility promoting agent, each based on the total weight of the stable solid agrochemical composition.

According to an embodiment of the present disclosure, the stable solid agrochemical composition comprises from about 1% w/w to about 50% w/w of a chloroacetanilide herbicide, from about 0.1% w/w to about 15% w/w of a sulfonylurea herbicide and from about 0.1% w/w to about 20% w/w of a suspensibility promoting agent, each based on the total weight of the stable solid agrochemical composition.

According to an embodiment of the present disclosure, the stable solid agrochemical composition comprises from about 10% w/w to about 40% w/w of a chloroacetanilide herbicide, from about 1% w/w to about 5% w/w of a sulfonylurea herbicide and from about 1% w/w to about 10% w/w of a suspensibility promoting agent, each based on the total weight of the stable solid agrochemical composition.

According to an embodiment of the present disclosure, the stable solid agrochemical composition comprises from about 5% w/w to about 45% w/w of a chloroacetanilide herbicide, from about 0.5% w/w to about 10% w/w of a sulfonylurea herbicide and from about 0.5% w/w to about 15% w/w of a suspensibility promoting agent, each based on the total weight of the stable solid agrochemical composition.

According to an embodiment of the present disclosure, the stable solid agrochemical composition comprises from about 1% w/w to about 50% w/w of a chloroacetanilide herbicide, from about 0.1% w/w to about 15% w/w of a triazinone herbicide and from about 0.1% w/w to about 20% w/w of a suspensibility promoting agent, each based on the total weight of the stable solid agrochemical composition.

According to an embodiment of the present disclosure, the stable solid agrochemical composition comprises from about 1% w/w to about 50% w/w chloroacetanilide herbicide, from about 0.1% w/w to about 15% w/w sulfonylurea herbicide, from about 1% w/w to about 40% w/w safener, and from about 0.1% w/w to about 20% w/w suspensibility promoting agent, each based on the total weight of the stable solid agrochemical composition.

According to an embodiment of the present disclosure, the stable solid agrochemical composition comprises from about 1% w/w to about 50% w/w pretilachlor, from about 0.1% w/w to about 15% w/w pyrazosulfuron-ethyl and from about 0.1% w/w to about 20% w/w suspensibility promoting agent, each based on the total weight of the stable solid agrochemical composition.

According to an embodiment of the present disclosure, the stable solid agrochemical composition comprises from about 1% w/w to about 50% w/w pretilachlor, from about 0.1% w/w to about 15% w/w pyrazosulfuron-ethyl and from about 0.1% w/w to about 20% w/w tristrylphenol ethoxylate sulfate, each based on the total weight of the stable solid agrochemical composition.

According to an embodiment of the present disclosure, the stable solid agrochemical composition comprises from about 1% w/w to about 50% w/w propisochlor, from about 0.1% w/w to about 15% w/w metribuzin and from about 0.1% w/w to about 20% w/w suspensibility promoting agent, each based on the total weight of the stable solid agrochemical composition.

According to an embodiment of the present disclosure, the stable solid agrochemical composition comprises from about 1% w/w to about 50% w/w pretilachlor, from about 0.1% w/w to about 15% w/w pyrazosulfuron-ethyl and from about 0.1% w/w to about 20% w/w tristrylphenol ethoxylate sulfate, each based on the total weight of the stable solid agrochemical composition, wherein said stable solid agrochemical composition is in the form of water dispersible granules.

According to an embodiment of the present disclosure, the stable solid agrochemical composition comprises from about 1% w/w to about 50% w/w propisochlor, from about 0.1% w/w to about 15% w/w metribuzin and from about 0.1% w/w to about 20% w/w tristrylphenol ethoxylate sulfate, each based on the total weight of the stable solid agrochemical composition, wherein said stable solid agrochemical composition is in the form of water dispersible granules.

According to an embodiment of the present disclosure, the stable solid agrochemical composition comprises from about 1% w/w to about 50% w/w pretilachlor, from about 0.1% w/w to about 15% w/w pyrazosulfuron-ethyl, from about 1% w/w to about 40% w/w fenclorim, and from about 0.1% w/w to about 20% w/w tristrylphenol ethoxylate sulfate, each based on the total weight of the stable solid agrochemical composition, wherein said stable solid agrochemical composition is in the form of water dispersible granules.

According to an embodiment of the present disclosure, the stable solid agrochemical composition comprises from about 1% w/w to about 50% w/w of a chloroacetanilide herbicide, from about 0.1% w/w to about 15% w/w of an anilide herbicide, and from about 0.1% w/w to about 20% w/w suspensibility promoting agent, each based on the total weight of the stable solid agrochemical composition.

According to an embodiment of the present disclosure, the stable solid agrochemical composition comprises from about 5% w/w to about 45% w/w of a chloroacetanilide herbicide, from about 0.5% w/w to about 10% w/w of ananilide herbicide and from about 0.5% w/w to about 15% w/w suspensibility promoting agent, each based on the total weight of the stable solid agrochemical composition.

According to an embodiment of the present disclosure, the stable solid agrochemical composition comprises from about 10% w/w to about 40% w/w of a chloroacetanilide herbicide, from about 1% w/w to about 5% w/w of an anilide herbicide and from about 1% w/w to about 10% w/w suspensibility promoting agent, each based on the total weight of the stable solid agrochemical composition.

According to an embodiment of the present disclosure, the stable solid agrochemical composition comprising from about 1% w/w to about 50% w/w of pretilachlor, from about 0.1% w/w to about 50% w/w of propanil and from about 0.1% w/w to about 20% w/w of a suspensibility promoting agent, each based on the total weight of the stable solid agrochemical composition.

According to an embodiment of the present disclosure, the stable solid agrochemical composition comprises from about 1% w/w to about 50% w/w of pretilachlor, from about 0.1% w/w to about 50% w/w of propanil and from about 0.1% w/w to about 20% w/w of tristrylphenol ethoxylate sulfate, each based on the total weight of the stable solid agrochemical composition.

According to an embodiment of the present disclosure, the stable solid agrochemical composition comprises from about 1% w/w to about 50% w/w of pretilachlor, from about 0.1% w/w to about 50% w/w of propanil and from about 0.1% w/w to about 20% w/w of tristrylphenol ethoxylate sulfate, each based on the total weight of the stable solid agrochemical composition wherein said stable solid agrochemical composition is in the form of water dispersible granules.

According to an embodiment of the present disclosure, the stable solid agrochemical composition comprises from about 1% w/w to about 50% w/w of pretilachlor, from about 0.1% w/w to about 15% w/w of propanil, from about 1% w/w to about 40% w/w of fenclorim, and from about 0.1% w/w to about 20% w/w of tristrylphenol ethoxylate sulfate, each based on the total weight of the stable solid agrochemical composition wherein said stable solid agrochemical composition is in the form of water dispersible granules.

According to an embodiment of the present disclosure, the stable solid agrochemical composition comprises a chloroacetanilide herbicide; at least one more herbicide, its salt or derivative thereof; and a suspensibility promoting agent; wherein suspensibility of chloroacetanilide herbicide in the said composition is greater than about 70 wt %, preferably greater than about 75 wt %, or more preferably greater than about 80 wt %.

According to an embodiment of the present disclosure, the stable solid agrochemical composition comprises a chloroacetanilide herbicide, a second herbicide, its salt or derivative; and a suspensibility promoting agent; wherein suspensibility of said composition is more than 80%.

An embodiment of the present disclosure provides a process of preparing a stable solid agrochemical composition wherein said process comprises:
(a) preparing a liquid portion by adding a chloroacetanilide herbicide, a suspensibility promoting agent, and optionally other auxiliary agents;
(b) separately, preparing a solid portion by adding one or more of a sulfonylurea, an anilide, a triazine or a triazinone herbicide, or a salt or derivative thereof and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) one or more of the sulfonylurea, anilide, triazine or triazinone herbicides, salt or derivatives thereof; (c) the suspensibility promoting agent; and the optionally other auxiliary agents.

An embodiment of the present disclosure provides a process of preparing a stable solid agrochemical composition wherein said process comprises:
(a) preparing a liquid portion by adding a chloroacetanilide herbicide, a suspensibility promoting agent, and optionally other auxiliary agents;
(b) separately, preparing a solid portion by adding at least one more herbicide selected from a sulfonylurea herbicide, or a salt or derivative thereof and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) at least one more herbicide selected from the sulfonylurea herbicides, salt or derivative thereof; (c) the suspensibility promoting agent; and the optionally other auxiliary agents.

An embodiment of the present disclosure provides a process of preparing a stable solid agrochemical composition wherein said process comprises:
(a) preparing a liquid portion by a chloroacetanilide herbicide, a suspensibility promoting agent, and optionally other auxiliary agents;
(b) separately, preparing a solid portion by adding at least one more herbicide selected from an anilide herbicide, or a salt or derivative thereof, milled safener and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) at least one more herbicide selected from the anilide herbicide, salt or derivative thereof; (c) the safener; (d) the suspensibility promoting agent and the optionally other auxiliary agents.

According to an embodiment of the present disclosure provides a process of preparing a stable solid agrochemical composition wherein said process comprises:
(a) preparing a liquid portion by adding a chloroacetanilide herbicide, a suspensibility promoting agent, and optionally other auxiliary agents;
(b) separately, preparing a solid portion by adding at least one more herbicide selected from an anilide herbicide, or a salt or derivative thereof, milled safener and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) at least one more herbicide selected from the triazinone herbicide, salt or derivative thereof; (c) the safener; (d) the suspensibility promoting agent; and the optionally other auxiliary agents.

An embodiment of the present disclosure provides a process of preparing a stable solid agrochemical composition wherein said process comprises:
(a) preparing a liquid portion by adding pretilachlor, a suspensibility promoting agent, and optionally other auxiliary agents;
(b) separately, preparing a solid portion by adding pyrazosulfuron-ethyl and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) pyrazosulfuron-ethyl; (c) the suspensibility promoting agent; and the optionally other auxiliary agents.

An embodiment of the present disclosure provides a process of preparing a stable solid agrochemical composition wherein said process comprises:
(a) preparing a liquid portion by adding propisochlor, a suspensibility promoting agent, and optionally other auxiliary agents;
(b) separately, preparing a solid portion by adding metribuzin and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) propisochlor, (b) metribuzin; (c) the suspensibility promoting agent; and the optionally other auxiliary agents.

An embodiment of the present disclosure provides a process of preparing a stable solid agrochemical composition wherein said process comprises:
(a) preparing a liquid portion by adding pretilachlor, a suspensibility promoting agent, and optionally other auxiliary agents;
(b) separately, preparing a solid portion by adding propanil, its salt or derivative and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) propanil, its salt or derivative; (c) the suspensibility promoting agent; and the optionally other auxiliary agents.

According to an embodiment of the present disclosure, a process of preparing a stable solid agrochemical composition wherein said process comprises:
(a) preparing a liquid portion by adding pretilachlor, tristrylphenol ethoxylate sulfate, water and optionally other auxiliary agents;
(b) separately, preparing a solid portion by adding pyazosulfuron-ethyl, milled fenclorim safener and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) pyrazosulfuron-ethyl, (c) tristrylphenol ethoxylate sulfate, (d) fenclorim, and the optionally other auxiliary agents.

According to an embodiment of the present disclosure, a process of preparing a stable solid agrochemical composition wherein said process comprises:
(a) preparing a liquid portion by adding pretilachlor, a suspensibility promoting agent, and optionally other auxiliary agents;
(b) separately, preparing a solid portion by adding propanil and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) propanil, (c) the suspensibility promoting agent, and the optionally other auxiliary agents.

An embodiment of the present disclosure provides a process of preparing a stable solid agrochemical composition wherein said process comprises:
(a) preparing a liquid portion by adding a chloroacetanilide herbicide, a suspensibility promoting agent, and optionally other auxiliary agents;
(b) separately, preparing a solid portion by adding one or more of a sulfonylurea, an anilide, triazine or a triazinone herbicides, salt or derivative thereof and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) the chloroacetanilide herbicide, (b) one or more of the sulfonylurea, anilide, triazine or triazinone herbicides, salt or derivatives thereof, (c) the safener; (d) the suspensibility promoting agent, and the optionally other auxiliary agents.

An embodiment of the present disclosure provides a process of preparing a stable solid agrochemical wherein said process comprises:
(a) preparing a liquid portion by adding pretilachlor, tristrylphenol ethoxylate sulfate, water and optionally other auxiliary agents;
(b) separately, preparing a solid portion by adding propanil, fenclorim and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) propanil, (c) tristrylphenol ethoxylate sulfate, (d) fenclorim, and the optionally other auxiliary agents.

An embodiment of the present disclosure provides a process of preparing a stable solid agrochemical composition wherein said process comprises steps of:
(a) preparing liquid portion by adding pretilachlor, tristrylphenol ethoxylate sulfate, water and optionally other auxiliary agents;
(b) separately, preparing solid portion by adding Pyrazosulfuron-ethyl, fenclorim and optionally other auxiliary agents;
(c) mixing the liquid portion of (a) with the solid portion of (b) to obtain a mixture; and
(d) granulating the mixture to provide granules and drying the granules thereby forming the solid agrochemical composition,
   wherein the solid agrochemical composition comprises (a) pretilachlor, (b) Pyrazosulfuron-ethyl, (c) tristrylphenol ethoxylate sulfate, (d) fenclorim, and the optionally other auxiliary agents.

According to an embodiment of the present disclosure, the order of addition and mixing of the granule ingredients is not critical. In one embodiment, for example, liquid portion and solid portion are blended separately and then mixed together to prepare mix.

According to an embodiment of the present disclosure, the blend of above ingredients is obtained using a blender such as a ribbon blender, V-blender, high intensity plough shear mixer, or the like.

According to an embodiment of the present disclosure, the grinding may be performed in a suitable device such as an air jet mill, air classifier mill, hammer mill, and pin disc mill. Jet mills are shear or pulverizing machines in which the particles to be milled are accelerated by gas flows and pulverized by collision. There are a number of different types of jet mill designs, such as double counter flow (opposing jet) and spiral (pancake) fluid energy mills.

According to an embodiment of the present disclosure, granulation of water dispersible granules is normally done through an extrusion process, pan granulation, fluidised bed spray granulation and spray drying process.

According to an embodiment of the present disclosure, drying of granules may be performed in a suitable drying equipment such as fluidised bed drier, tray drier, and Rotocone vacuum drier.

According to an embodiment of the present disclosure, the drying of extruded granules is carried out at a temperature not more than 100° C., preferably not more than 90° C.

Preferably, the drying of extruded granules operates at a temperature range of 50° C.-70° C.

The drying process will preferably remove as much water as possible in order to reduce weight and to provide good stability to the granules while still in a dry flowable state.

Preferably the granules will be dried to less than 2% as weight loss on complete drying and most preferably dried to less than 0.5% as weight loss on complete drying. Complete drying means that 100% of water has been removed from the extruded granules.

According to an embodiment of the present disclosure, dried granules are taken for sieving to remove undersized and oversized granules.

According to an embodiment of the present disclosure, the materials used in the process of the disclosure may be in a finely divided form, preferably in an air-milled form, which is generally the form of technical grade chemicals supplied by manufacturers.

After thorough mixing or after otherwise putting the mix into a form suitable for extrusion, extrusion may take place through suitable orifices. The size of the granules will depend upon the size of the orifices and the extruder may thus be fitted with a mesh or die selected to provide a desired size of granule. Preferably extrusion orifices will be chosen to provide extrusions between 300 and 3000 microns in diameter. The extrusions can vary considerably in length, e.g. up to 0.5 cm or more long.

In an embodiment of the present disclosure, the pH of the stable solid agrochemical composition is between 5 to 8.

The process described herein considerably reduces the amount of oversized and undersized material which must be recycled. Consequently, the granule composition is essentially dust free.

An embodiment of the present disclosure provides a method of controlling unwanted weeds, said method comprising, applying an effective amount of stable solid agrochemical composition comprising (a) a chloroacetanilide herbicide, (b) a second herbicide, salt or derivative thereof and (c) a suspensibility promoting agent to the weeds or to their locus.

An embodiment of the present disclosure provides a method of controlling unwanted weeds, said method comprising, applying an effective amount of stable solid agrochemical composition comprising (a) a chloroacetanilide herbicide, (b) at least one sulfonylurea herbicide, its salt or derivative and (c) a suspensibility promoting agent to the weeds or to their locus.

An embodiment of the present disclosure provides a method of controlling unwanted weeds, said method comprising, applying an effective amount of stable solid agrochemical composition comprising (a) a chloroacetanilide herbicide, (b) at least one triazinone herbicide, its salt or derivative and (c) a suspensibility promoting agent to the weeds or to their locus.

An embodiment of the present disclosure provides a method of controlling unwanted weeds, said method comprising, applying an effective amount of stable solid agrochemical composition comprising (a) a chloroacetanilide herbicide, (b) at least one anilide herbicide, its salt or derivative and (c) a suspensibility promoting agent to the weeds or to their locus.

An embodiment of the present disclosure provides a method of controlling unwanted weeds, said method comprising, applying an effective amount of stable solid agrochemical composition comprising (a) pretilachlor, (b) pyrazosulfuron-ethyl and (c) a suspensibility promoting agent to the weeds or to their locus.

An embodiment of the present disclosure provides a method of controlling unwanted weeds, said method comprising, applying an effective amount of stable solid agrochemical composition comprising (a) propisochlor, (b) metribuzin and (c) a suspensibility promoting agent to the weeds or to their locus.

An embodiment of the present disclosure provides a method of controlling unwanted weeds, said method comprising, applying an effective amount of stable solid agrochemical composition comprising (a) a pretilachlor, (b) propanil and (c) a suspensibility promoting agent to the weeds or to their locus.

An embodiment of the present disclosure provides a method of controlling unwanted weeds, said method comprising, applying an effective amount of stable solid agrochemical composition comprising (a) a pretilachlor, (b) pyrazosulfuron-ethyl, (c) fenclorim and (d) a suspensibility promoting agent to the weeds or to their locus.

An embodiment of the present disclosure provides a method of controlling unwanted weeds, said method comprising, applying an effective amount of stable solid agrochemical composition comprising (a) a pretilachlor, (b) propanil and (c) a suspensibility promoting agent; to the weeds or to their locus.

An embodiment of the present disclosure provides a method of controlling unwanted weeds, said method comprising, applying an effective amount of stable solid agrochemical composition comprising (a) a chloroacetanilide herbicide, (b) at least one more herbicide, its salt or derivative thereof, (c) a safener and (d) a suspensibility promoting agent to the weeds or to their locus.

An embodiment of the present disclosure provides a method of controlling unwanted weeds, said method comprising, applying an effective amount of stable solid agrochemical composition comprising (a) a pretilachlor, (b) propanil, (c) fenclorim and (d) a suspensibility promoting agent to the weeds or to their locus.

An embodiment of the present disclosure provides a method of controlling germination loss in crop seeds, said method comprising, applying an effective amount of stable solid agrochemical composition comprising (a) a chloroacetanilide herbicide, (b) at least one more herbicide, its salt or derivative, (c) a safener and (d) a suspensibility promoting agent to the crop seeds or to their locus.

An embodiment of the present disclosure provides a method of controlling germination loss in crop seeds, said method comprising, applying an effective amount of stable solid agrochemical composition comprising (a) a chloroacetanilide herbicide, (b) a second herbicide, its salt or derivative, (c) a safener and (d) a suspensibility promoting agent; to the dry directly seeded rice seeds or to their locus.

An embodiment of the present disclosure provides a method of controlling germination loss in crop seeds, said method comprising, applying an effective amount of stable solid agrochemical composition comprising (a) a chloroacetanilide herbicide, (b) a second herbicide, its salt or derivative, and (c) a suspensibility promoting agent; to the locus of oil crops such as soyabean or rapeseed oil.

An embodiment of the present disclosure provides a method of controlling germination loss in crop seeds, said method comprising, applying an effective amount of stable solid agrochemical composition comprising (a) pretilachlor, (b) pyrazosulfuron-ethyl (c) fenclorim and (d) tristrylphenol ethoxylate sulfate; to the dry directly seeded rice seeds or to their locus.

An embodiment of the present disclosure provides a method of controlling germination loss in crop seeds, said method comprising, applying an effective amount of stable solid agrochemical composition comprising (a) pretilachlor, (b) propanil (c) fenclorim and (d) tristrylphenol ethoxylate sulfate; to the dry directly seeded rice seeds or to their locus.

An embodiment of the present disclosure provides a method of controlling weeds, said method comprising, applying an effective amount of stable solid agrochemical composition comprising (a) propisochlor, (b) metribuzin and (d) tristrylphenol ethoxylate sulfate; to the locus of oil crops such as soyabean or rapeseed oil. According to an embodiment of the present disclosure, stable solid agrochemical composition controls more than 90% germination loss in seeds.

According to an embodiment of the present disclosure, stable solid agrochemical composition controls more than 95% germination loss in seeds.

According to an embodiment of the present disclosure, stable solid agrochemical composition controls more than 99% germination loss in seeds.

According to an embodiment of the present disclosure, the stable solid agrochemical composition is applied in such a way that the required amount of the stable solid agrochemical composition is mixed with the same amount or up to ten times the amount of water, and applied directly to the already flooded paddy field, or as foliar application or is added to the water flowing in during flooding of the paddy field (so-called splash application).

Furthermore, it is also possible, to apply the stable solid agrochemical composition dropwise or in portions simultaneously with the mechanical planting of the rice plants (so-called dip application). Spray application of the stable solid agrochemical composition according to the disclosure is similarly possible but requires a higher dilution with water.

According to an embodiment of the present disclosure, the application rates of stable solid agrochemical composition according to the disclosure may vary within a wide range. It is preferable to use 50 to 2000 g/ha herbicide (chloroacetanilide herbicide plus another herbicide type).

According to an embodiment of the present disclosure, the stable solid agrochemical contains per litre preferably 10 to 300 g chloroacetanilide herbicide and 10 to 100 g sulfonylurea herbicide, 10 to 100 g safener, 10 to 100 g suspensibility promoting agent as well as 50 to 300 g of dispersants (anionic plus non-ionic). Normally, 2-20 I/ha of the composition described below by way of example are used for direct application or for splash application. For spray application, this amount is usually 20-500 I/ha.

According to an embodiment of the present disclosure, the stable solid agrochemical composition according to the disclosure contains per litre preferably 10 to 300 g chloroacetanilide herbicide and 10 to 100 g anilide herbicide, 10 to 100 g safener, 10 to 100 g suspensibility promoting agent as well as 50 to 300 g of dispersants (anionic plus non-ionic). Normally, 2-20 I/ha of the composition described below by way of example are used for direct application or for splash application. For spray application, this amount is usually 20-500 I/ha.

According to an embodiment of the present disclosure, the stable solid agrochemical composition is used as herbicide.

According to an embodiment of the present disclosure, the stable solid agrochemical composition is used to control broad spectrum of annual and perennial weeds at pre- and post-emergence stages.

According to an embodiment of the present disclosure, the stable solid agrochemical composition controls weeds in flooded paddy fields.

According to an embodiment of the present disclosure, the stable solid agrochemical composition requires a formulation which allows the active compounds to be taken up by the plants.

According to an embodiment of the present disclosure, the stable solid agrochemical composition is used as the source of active agrochemical ingredient(s) and will typically be diluted to form end-use formulations, typically spray formulations. The dilution may be with water at from 1 to 10,000, particularly 10 to 1,000, times the total weight of the stable solid agrochemical composition to form the spray formulation. Said stable solid agrochemical composition may be diluted for use having an agrochemical active concentration of about 0.5 wt. % to about 1 wt. %. In said diluted composition the agrochemical active concentration may be in the range from about 0.001 wt. % to about 1 wt. % of the total formulation as sprayed. As used herein the agrochemical active concentration is calculated by dividing the sum of the amounts of all the herbicides in the composition by the total weight of the composition.

Spray formulations include all the components which it is desired to apply to the plants or their environment. Spray formulations can be made up by simple dilution of stable solid agrochemical composition containing agrochemically active ingredients, or by mixing of the individual agrochemically active ingredients, or a combination of diluting a stable solid agrochemical composition and adding further individual agrochemically active ingredients or mixtures of agrochemically active ingredients. Typically, such end use mixing is carried out in the tank from which the formulation is sprayed, or alternatively in a holding tank for filling the spray tank. Such mixing and mixtures are typically termed tank mixing and tank mixtures. According to an embodiment of the present disclosure, a kit comprising stable solid agrochemical composition is provided.

According to an embodiment of the present disclosure, a kit comprises:
a chloroacetanilide herbicide;
a second herbicide, its salt or derivative; and
a suspensibility promoting agent.

According to an embodiment of the present disclosure, a kit comprises:
a chloroacetanilide herbicide;
at least one sulfonylurea herbicide, or its salt or derivative; and
a suspensibility promoting agent.

According to an embodiment of the present disclosure, a kit comprises:
a chloroacetanilide herbicide;
at least one anilide herbicide, or its salt or derivative; and
a suspensibility promoting agent.

According to an embodiment of the present disclosure, a kit comprises:
a chloroacetanilide herbicide;
at least one triazinone herbicide, or its salt or derivative; and
a suspensibility promoting agent.

In one embodiment of the present disclosure, the kits may include one or more, including all, components that may be used to prepare the stable solid agrochemical composition. For example, kits may include chloroacetanilide herbicide, a second herbicide, and suspensibility promoting agent. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for stable solid agrochemical composition.

In both forms, a component of the kit may be applied separately from or together with the further components or as a component of a combination composition according to the disclosure for preparing the stable solid agrochemical composition according to the disclosure.

In an embodiment of the present disclosure, the stable solid agrochemical composition comprises (a) a chloroacetanilide herbicide, (b) a sulfonylurea herbicide, and (c) suspensibility promoting agent is in the form of a kit with single pack or multi pack.

In an embodiment of the present disclosure, the stable solid agrochemical composition comprises (a) a chloroacetanilide herbicide, (b) a anilide herbicide, and (c) suspensibility promoting agent is in the form of a kit with single pack or multi pack.

In an embodiment of the present disclosure, the stable solid agrochemical composition comprises (a) a chloroacetanilide herbicide, (b) a triazinone herbicide, and (c) suspensibility promoting agent is in the form of a kit with single pack or multi pack.

It will be understood that the specification and examples are illustrative but not limitative of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

### Example 1: Preparation of 30% w/w Pretilachlor+0.85% w/w Pyrazosulfuron-Ethyl WDG

| Ingredients | Quantity (% w/w) |
|---|---|
| Pretilachlor | 33 |
| Pyrazosulfuron Ethyl | 0.85 |
| Tristrylphenol ethoxylate sulfate | 4 |
| (suspensibility promoting agent) | |
| Sodium lignosulfonate (dispersant) | 25 |
| Precipitated silica (filler) | 16 |
| Kaolin (filler) | QS |
| Total | 100 |

To prepare the liquid portion, 4 g tristrylphenol ethoxylate sulfate was dissolved in water and further 33 g pretilachlor was added. Separately, to prepare the solid portion, 0.85 g pyrazosulfuron-ethyl, 16 g precipitated silica, 25 g sodium lignosulfonate and kaolin were charged in a reactor equipped with a high shear mixer. The liquid portion comprising pretilachlor was added to the solid portion in a reactor and blended together to obtain a mixture. The mixture was then taken to a plough shear mixer to obtain a mixture. Granules were extruded from the mixture and dried at a temperature less than 90° C. to reduce the moisture content to less than 2%. The granules were sieved and packed after quality inspection.

### Example 2: Preparation of 30% w/w Pretilachlor+0.85% w/w Pyrazosulfuron-Ethyl WDG

| Ingredients | Quantity (% w/w) |
|---|---|
| Pretilachlor Technical | 33 |
| Pyrazosulfuron Ethyl technical | 0.85 |
| Tristrylphenol ethoxylate sulfate | 3.5 |
| Sodium lignosulfonate (dispersant) | 25 |
| Precipitated silica (filler) | 16 |
| Kaolin (filler) | QS |
| Total | 100 |

Pretilachlor, Pyrazosulfuron-ethyl, tristrylphenol ethoxylate, sodium lignosulfonate, precipitated silica, kaolin were mixed in a given ratio shown above and granules were prepared as per the process of Example 1.

### Example 3: Preparation of 30% w/w Pretilachlor+0.85% w/w Pyrazosulfuron-Ethyl WDG

| Ingredients | Quantity (% w/w) |
|---|---|
| Pretilachlor Technical | 33 |
| Pyrazosulfuron Ethyl technical | 0.85 |
| Fenclorim | 3.5 |
| Tristrylphenol ethoxylate sulfate | 3.5 |
| (suspensibility promoting agent) | |
| Sodium lignosulfonate | 25 |
| (dispersant) | |
| Supragil ® WP (wetting agent) | 1.0 |
| Precipitated silica (filler) | 18 |
| Kaolin | QS |
| Total | 100 |

Pretilachlor, Pyrazosulfuron-ethyl, fenclorim, tristrylphenol ethoxylate, sodium lignosulfonate, precipitated silica, supragyl WP and kaolin were mixed in a given ratio shown above and granules were prepared as per the process of Example 1.

### Example 4: Preparation of 30% w/w Pretilachlor+0.85% w/w Pyrazosulfuron-Ethyl WDG (Comparative Example—No Suspensibility Promoting Agent)

| Ingredients | Quantity (% w/w) |
|---|---|
| Pretilachlor Technical | 33 |
| Pyrazosulfuron Ethyl technical | 0.85 |
| Sodium lignosulfonate (filler) | 25 |
| Precipitated silica (filler) | 16 |
| Kaolin | QS |
| Total | 100 |

Pretilachlor, Pyrazosulfuron-ethyl, sodium lignosulfonate, precipitated silica and kaolin were mixed in a given ratio shown above and granules were prepared as per the process of Example 1.

### Example 5: Preparation of Pretilachlor 30%+Pyrazosulfuron Ethyl (PSE) 0.75% w/w WG

| Ingredients | Quantity (% w/w) |
|---|---|
| Pretilachlor Technical | 32.0 |
| Pyrazosulfuron Ethyl technical | 0.83 |
| Tristrylphenol ethoxylate sulfate | 3.5 |
| (suspensibility promoting agent) | |
| Sodium lignosulfonate (dispersant) | 25 |
| Supragil ® WP (wetting agent) | 1.0 |
| Precipitated silica (filler) | 18 |
| Kaolin (filler) | QS |
| Total | 100 |

### Example 6: Preparation of Pretilachlor 30%+PSE 0.75% w/w WG

| Ingredients | Quantity (% w/w) |
|---|---|
| Pretilachlor Technical | 32.0 |
| Pyrazosulfuron Ethyl technical | 0.83 |
| Fenclorim | 3.5 |
| Tristrylphenol ethoxylate sulfate | 3.5 |
| (suspensibility promoting agent) | |
| Sodium lignosulfonate (dispersant) | 25 |
| Supragil ® WP (wetting agent) | 1.0 |
| Precipitated silica (filler) | 18 |
| Kaolin (filler) | QS |
| Total | 100 |

### Example 7: Propisochlor 28.8%+Metribuzin 4.2% w/w WG

| Ingredients | Quantity (% w/w) |
|---|---|
| Propisochlor Technical | 32.41 |
| Metribuzin Technical | 4.5 |
| Tristrylphenol ethoxylate sulfate | 4.0 |
| (suspensibility promoting agent) | |
| Sodium lignosulfonate (dispersant) | 25 |
| Supragil ® WP (wetting agent) | 1.0 |
| Precipitated silica (filler) | 18 |
| Kaolin (filler) | QS |
| Total | 100 |

### Example 8: Propisochlor 28.8%+Metribuzin 4.2% w/w WG

| | |
|---|---|
| Propisochlor technical | 32.41 |
| Metribuzin technical | 04.5 |
| Tristrylphenol ethoxylate sulfate | 3.5 |
| (suspensibility promoting agent) | |
| Sodium lignosulfonate (dispersant) | 25 |
| Supragil ® WP (wetting agent) | 1.0 |
| Precipitated silica (filler) | 18 |
| Kaolin (filler) | QS |
| Total | 100 |

### Test for Suspensibility

The WDG compositions of Example-1-3 and Example-4 prepared according to the present disclosure were investigated for suspensibility of chloroacetanilide herbicide and Pyrazosulfuron-ethyl (PSE) herbicide as well as its effect on stability of the composition. The stability study was conducted for zero days and 14 days AHS (Accelerated Heat Stability) at 54±2° C. Physicochemical parameters defining stability such as suspensibility and wet sieve content were tested for 0 days in ambient condition and 14 days in AHS respectively. The results are summarized in Table 1.

TABLE 1

| | Example-1 | | Example-2 | | Example-3 | | Example-4 | |
|---|---|---|---|---|---|---|---|---|
| Parameters | 0 Day | 14 Days | 0 Day | 14 Days | 0 Day | 14 Days | 0 Day | 14 Days |
| Pretilachlor | 31.20 | 31.15 | 30.85 | 30.43 | 30.00 | 29.61 | 30.36 | 29.91 |
| Content (% w/w) | | | | | | | | |
| Pretilachlor | 87.95 | 85.23 | 85.01 | 81.28 | 83.81 | 78.68 | 59.36 | 58.01 |
| Suspensibility | | | | | | | | |
| (% w/w) | | | | | | | | |
| Wet sieve | 0.80 | 0.83 | 0.88 | 0.89 | Nil | Nil | 1.41 | 1.52 |
| (% w/w) | | | | | | | | |
| PSE Content | 0.85 | 0.82 | 0.919 | 0.896 | 0.835 | 0.818 | 0.855 | 0.819 |
| (% w/w) | | | | | | | | |
| PSE | 102 | 101.20 | 99.32 | 98.80 | 98.24 | 98.01 | 100.59 | 99.01 |
| Suspensibility | | | | | | | | |
| (% w/w) | | | | | | | | |
| Fenclorim | NA | NA | NA | NA | 2.99 | 2.87 | NA | NA |
| Content (% w/w) | | | | | | | | |
| Fenclorim | NA | NA | NA | NA | 83.79 | 78.17 | NA | NA |
| Suspensibility | | | | | | | | |
| (% w/w) | | | | | | | | |

### PSE is Pyrazosulfuron Ethyl

As it is clear from Table 1, compositions of Example-1, Example-2 and Example-3 prepared according to the present disclosure showed high suspensibility of both pretilachlor and pyrazosulfuron-ethyl. In Example-1, the suspensibility of pretilachlor observed was 87.95% in 0 days and 85.23% in 14 days. In Example-2, the suspensibility of pretilachlor observed was 85.01% in 0 days and 81.28% in 14 days. In Example-3, the suspensibility of pretilachlor observed was 83.81% in 0 days and 78.68% in 14 days. In both ambient (0 days) and AHS (14 days), good suspensibility of pretilachlor and pyrazosulfuron-ethyl was obtained. This shows suspensibility of pretilachlor remains nearly constant with a slight drop within acceptable range. Similarly, in Example-1, the suspensibility of pyrazosulfuron-ethyl observed was 102% in 0 days and 101.20% in 14 days, in Example-2, the suspensibility of pyrazosulfuron-ethyl observed was 99.32% in 0 days and 98.80% in 14 days, in Example-3, the suspensibility of pyrazosulfuron-ethyl observed was 98.24% in 0 days and 98.01% in 14 days. This shows nearly constant suspensibility of pyrazosulfuron-ethyl with negligible drop in ambient as well as 14 days AHS. Contrastingly, 59.3% suspensibility of pretilachlor was observed for composition of Example-4 in 0 days.

Similarly, compositions of Example-7 and Example-8 prepared according to the present disclosure showed high suspensibility of both propisochlor and metribuzin. In Example-7, the suspensibility of propisochlor observed was 78.2% in 0 days and 74.7% in 14 days. In Example-8, the suspensibility of propisochlor observed was 93.97% in 0 days and 81.3 in 14 days. In both ambient (0 days) and AHS (14 days), good suspensibility of propisochlor was seen with a slight variation within acceptable range. Also, a very little degradation of both propisochlor and metribuzin was observed in both ambient and AHS studies. Further, in Example-7, the suspensibility of metribuzin observed was 91.61% in 0 days and 91.03% in 14 days, in Example-8, the suspensibility of metribuzin observed was 98.35% in 0 days and 95% in 14 days. This shows nearly constant suspensibility of metribuzin with slight drop in ambient as well as 14 days AHS within acceptable range (Table 2).

TABLE 2

| | Example-7 | | Example-8 | |
|---|---|---|---|---|
| Parameters | 0 Day | 14 Days | 0 Day | 14 Days |
| Propisochlor Content (% w/w) | 28.55 | 28.32 | 28.30 | 28.03 |
| Propisochlor Suspensibility | 78.2 | 74.7 | 93.97 | 81.3 |
| (% w/w) | | | | |
| Wet sieve (% w/w) | Nil | Nil | Nil | Nil |
| Metribuzin Content (% w/w) | 4.36 | 4.29 | 4.31 | 4.24 |
| Metribuzin Suspensibility (% | 91.61 | 91.03 | 98.35 | 95.0 |
| w/w) | | | | |

### Real Time Study

The compositions of Example-5 and Example-6 were used in a real time study. In the composition of Example-5, active pretilachlor remained almost constant with a negligible decrease from 30.97 (0 days) to 30.36 (18 months). Similarly, a slight degradation of active pyrazosulfuron-ethyl was observed from 0.826 (0 days) to 0.76 (18 months). The suspensibility of pretilachlor remained under control i.e., 84.36% (0 days) to 80.15% (18 months) and of pyrazosulfuron-ethyl, from 99.21 (0 days) to 93.98 (18 months). A negligible change in the wet sieve retention of the composition of Example-5 from 0.05 to 0.1 was observed.

Further, in the composition of Example-6, active pretilachlor remained almost constant with a negligible decrease from 30.92 (0 days) to 30.21 (18 months). Similarly, a slight degradation of active pyrazosulfuron-ethyl was observed from 0.829 (0 days) to 0.819 (18 months) and of fenclorim from 3.25 (0 days) to 3.08 (18 months). Quite good suspensibility of the pretilachlor was observed throughout the real time study, 77.12% (0 days) to 62.55% (18 months) and of pyrazosulfuron-ethyl, from 99.33 (0 days) to 98.50 (18 months). A negligible change in the wet sieve retention of the composition of Example-6 from 0.045 to 0.11 was observed. (Table 3)

TABLE 3

| | | Results | | | |
|---|---|---|---|---|---|
| | | 0 | 6 | 12 | 18 |
| # | Parameters | Day | Months | Months | Months |

Example-5

| | | | | | |
|---|---|---|---|---|---|
| 1. | Active Content (% w/w) | | | | |
| | 1. PSE | 0.8261 | 0.801 | 0.795 | 0.76 |
| | 2. Pretilachlor | 30.97 | 30.75 | 30.52 | 30.36 |
| 2. | Suspensibility (% w/w) | | | | |
| | 1. PSE | 99.21 | 98.70 | 95.5 | 93.98 |
| | 2. Pretilachlor | 84.36 | 83.50 | 81.50 | 80.15 |
| 3. | Wet Sieve test (% w/w) | 0.05 | 0.05 | 0.01 | 0.1 |

Example-6

| | | | | | |
|---|---|---|---|---|---|
| 1. | Active Content (% w/w) | | | | |
| | 1. PSE | 0.829 | 0.825 | 0.820 | 0.819 |
| | 2. Pretilachlor | 30.92 | 30.65 | 30.22 | 30.21 |
| | 3. Fenclorim | 3.25 | 3.12 | 3.09 | 3.08 |
| 2. | Suspensibility (% w/w) | | | | |
| | 1. PSE | 99.33 | 99.30 | 99.29 | 98.50 |
| | 2. Pretilachlor | 77.12 | 72.5 | 69.77 | 62.55 |
| | 3 Fenclorim | 75.56 | 72.90 | 68.48 | 62.62 |
| 3. | Wet Sieve (% w/w) | 0.045 | 0.05 | 0.1 | 0.11 |

### Phytotoxicity Study

Phytotoxicity of the composition prepared according to the present disclosure was tested on Dry Direct Seeded Rice (DDSR) seeds. The objective of the phytotoxicity study was to evaluate the percent loss in germination of DDSR seeds after being treated with the compositions prepared according to the present disclosure.

### Test Protocol:

### Crop: Rice

Water Volume (1/ha): 500

### Application Timings: Pre-emergence and Delayed Pre-emergence

Crop Growth stage: 0 leaf
Soil Type: Alluvial soil (Chattisgarh region) and Deep black (Andhra Pradesh region)

The percentage crop injury from the composition of Example-3 comprising pretilachlor, pyrazosulfuron-ethyl and fenclorim was compared with a marketed product comprising pretilachlor and pyrazosulfuron-ethyl (Eros Gold®) at the rate of 615 g AI/Ha. Eros Gold® contains no suspensibility promoting agent. The composition of Example-3 and the marketed product were applied to DDSR seeds in three different ways: (1) spray application: wherein the both were separately diluted with water and applied as spray in respective regions; (2) mixing with sand: wherein both the compositions were separately mixed with sand and applied in respective regions; and (3) mixing with urea: wherein both the compositions were separately mixed with urea and applied in respective regions. All the three applications were repeated twice in two different geographies (one in Chattisgarh, India and another in Andhra Pradesh, India).

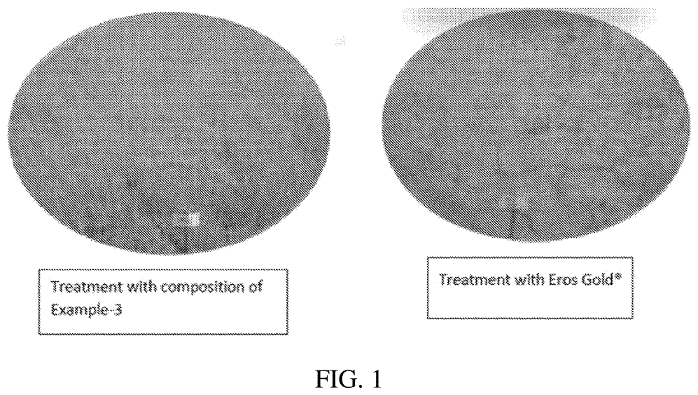

Observations were made at 3DAA (3 days after application), 5DAA (5 days after application) and 15DAA (15 days after application). In all the three applications (spray, sand-mix and urea-mix) of the composition of Example-3, significant germination loss was not observed at 3DAA, 5DAA and 15DAA wherein Eros Gold® showed 50% germination loss. It was concluded that the composition of Example-3 comprising pretilachlor, pyrazosulfuron-ethyl and fenclorim having a suspensibility promoting agent at the rate of 615 g AI/Ha did not cause any germination loss in the Dry Direct Seeded Rice (DDSR). However, marketed product comprising pretilachlor and pyrazosulfuron-ethyl (Eros Gold®) at the rate of 615 g AI/Ha caused 50% germination loss in the DDSR. (FIG. 1) and (Table-4)

TABLE 4

| | Active | | | | | |
|---|---|---|---|---|---|---|
| Treatment | Rate (g | Application | Appl. | | | |
| details | AI/ha) | Method | code | 3DAA | 7DAA | 15DAA |
| Untreated | 615 | — | — | — | — | — |
| check | | | | | | |
| Eros Gold ® | 615 | Spray | A | 50 | 50 | 50 |
| Example-3 | 615 | Spray | A | 0 | 0 | 0 |
| Eros Gold ® | 615 | Sand Mix | A | 50 | 50 | 50 |
| Example-3 | 615 | Sand Mix | A | 0 | 0 | 0 |
| Eros Gold ® | 615 | Urea Mix | A | 50 | 50 | 50 |
| Example-3 | 615 | Urea Mix | A | 0 | 0 | 0 |
| Eros Gold ® | 615 | Spray | B | 10 | 10 | 10 |
| Eros Gold ® | 615 | Spray | C | 0 | 0 | 0 |

The compositions developed according to the present disclosure remain stable according to the physico-chemical parameters. This signifies that the WG compositions of chloroacetanilide herbicide, especially those which are in liquid state with other herbicides prepared using suspensibility promoting agent not only possess excellent stability of the active ingredients but also retain the suspensibility. The combination of actives and suspensibility promoting agent prepared according to the process disclosed in the present disclosure leads to stable WG composition which does not undergo any chemical and physical changes on storage and is also easy to handle for further use. Also, the presence of a safener in the stable agrochemical composition according to present disclosure exhibited reduced crop injury making its application safe onto crops such as paddy/rice.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers. The terms “comprising”, “having”, “including”, and “containing” are to be construed as open-ended terms (i.e., meaning “including, but not limited to”) unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or 5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

As used herein, the term “controlling unwanted weeds” refers to the interference with the normal growth and development of undesired vegetation. Examples of control activity include, but are not limited to, inhibition of root growth, inhibition of shoot growth, inhibition of shoot emergence, inhibition of seed production, or reduction of weed bio mass. The term “unwanted weeds” applies to any plant or a part thereof growing in a place which is hindered, disturbed, obstructed by its presence stressing the need for its control or complete removal. Such a plant can be a weedy plant or a crop plant growing in undesirable places. As used herein, the terms “undesirable weeds” and “unwanted weeds” are synonymous.

As used herein, the term “effective amount” refers to an amount of the compound that, when ingested, contacted with or sensed, is sufficient to achieve a good level of control.

1. A solid agrochemical composition comprising: a. a chloroacetanilide herbicide; b. a second herbicide, a salt or derivative thereof; and c. a suspensibility promoting agent.

2. The composition of claim 1, wherein the suspensibility of the chloroacetanilide herbicides in the solid agrochemical compositions is greater than 70 wt % when measured according to CIPAC guidelines.

3. The solid agrochemical composition as claimed in claim 1, wherein the chloroacetanilide herbicide is one or more of pretilachlor and propisochlor.

4. The solid agrochemical composition as claimed in claim 1, wherein the second herbicide is one or more of a sulfonylurea herbicide, an anilide herbicide, a triazinone herbicide, a salt and a derivative thereof.

5. The solid agrochemical composition as claimed in claim wherein the sulfonylurea herbicide is one or more of bensulfuron, ethoxysulfuron, halosulfuron, nicosulfuron, propyrisulfuron, pyrazosulfuron, rimsulfuron, chlorsulfuron, metsulfuron, tribenuron, a salt and a derivative thereof.

6. The solid agrochemical composition as claimed in claim wherein the anilide herbicide is one or more of flufenacet, mefenacet, metamifop, monalide, naproanilide, picolinafen, propanil, sulfentrazone, a salt and a derivative thereof.

7. The solid agrochemical composition as claimed in claim wherein the triazinone herbicide is one or more of ametridione, amibuzin, metribuzin, metamitron, and trifludimoxazin.

8. The solid agrochemical composition a claimed in claim 1, wherein the suspensibility promoting agent is one or more of an ethoxylated tristyrylphenol sulfate, an ethoxylated tristyrylphenol phosphate, an ethoxylated vegetable oil, an ethoxylated fat alcohol, an ethoxylated alkylphenol, an ethoxylated polyethylene glycol, an ethoxylated polypropylene glycol, a copolymer of an ethoxylated polyethylene glycol and an ethoxylated polypropylene glycol, an ethoxylated tristyrylphenol derivative, a polyethylene oxide/polypropylene oxide block copolymer, a copolymer of a polyvinyl alcohol and a polyvinylpyrrolidone; and a copolymer of a (meth)acrylic acid and a (meth)acrylic ester.

9. The solid agrochemical composition a claimed in claim 1, wherein the suspensibility promoting agent is one or more of an ethoxylated tristyrylphenol sulfate and an ethoxylated tristyrylphenol phosphate.

10. The solid agrochemical composition as claimed in claim 1, wherein said composition is in the form of water dispersible granules (WDG).

11. The solid agrochemical composition as claimed in claim 1, wherein said composition comprises from about 1% w/w to about 50% w/w of the chloroacetanilide herbicide, from about 0.1% w/w to about 30% w/w of the second herbicide, the salt or derivative thereof, and from about 0.1% w/w to about 20% w/w of the suspensibility promoting agent, each based on the total weight of the solid agrochemical composition.

12. The solid agrochemical composition of claim 1, wherein the second herbicide is one or more of a sulfonylurea herbicide, an anilide herbicide, a triazine herbicide, a triazinone herbicide, a salt, and a derivative thereof; and the solid agrochemical composition further comprises a safener.

13. The solid agrochemical composition as claimed in claim 12, wherein said composition comprises from about 1% w/w to about 40% w/w of the safener based on the total weight of the solid agrochemical composition.

14. The solid agrochemical composition as claimed in claim 12, wherein the safener is one or more of benoxacor, fenclorim, cloquintocet-mexyl, and dichlormid.

15. The solid agrochemical composition as claimed in claim 12, wherein the safener is fenclorim.

16. A process of preparing a solid agrochemical composition wherein said process comprises:
(a) preparing a liquid portion by combining a chloroacetanilide herbicide, a suspensibility promoting agent, and optionally other auxiliary agents;
(b) separately, preparing a solid portion by combining one or more of a sulfonylurea herbicide, an anilide herbicide, a triazinone herbicide, a salt or derivative thereof and optionally other auxiliary agents;
(c) mixing the liquid portion of (a) with the solid portion of (b) to obtain a mixture; and
(d) granulating the mixture to provide granules and drying the granules thereby forming the solid agrochemical composition, wherein the solid agrochemical composition comprises (a) the chloroacetanilide herbicide, (b) the one or more of the sulfonylurea herbicide, anilide herbicide, triazine herbicide, triazinone herbicide, salt or derivative thereof; and (c) the suspensibility promoting agent; and the optionally other auxiliary agents.

17. (canceled)

18. The process as claimed in claim 16, wherein the granules of (d) are obtained through an extrusion process, a pan granulation, a fluidised bed spray granulation or a spray drying process.

19. The process of as claimed in claim 16, wherein drying the granules in (d) is carried out at a temperature no more than 90° C.-100° C.

20. A method of controlling unwanted weeds, said method comprising, applying an effective amount of the solid agrochemical composition of claim 4 to the weeds or to a locus thereof.

21. The method of controlling unwanted weeds, said method comprising applying an effective amount of the solid agrochemical composition of claim 12 to the weeds or to a locus thereof.

22. A method of controlling germination loss in crop seeds wherein said method comprising, applying an effective amount of the solid agrochemical composition of claim 12 to the crop seeds or to a locus thereof.

23. The method of controlling germination loss in crop seeds as claimed in claim 22, wherein said method comprising, applying an effective amount of solid agrochemical composition comprising (a) pretilachlor, (b) pyrazosulfuron-ethyl, (c) fenclorim; and (d) tristrylphenol ethoxylate sulfate to the weeds or to their locus.
